(19) United States
(12) Patent Application Publication
(10) Pub. No.: US 2021/0104094 A1
(43) Pub. Date: Apr. 8, 2021

(54) IMAGE PROCESSING TO DETERMINE RADIOSITY OF AN OBJECT

(71) Applicant: The Australian National University, Action Australian Capital Territory (AU)

(72) Inventors: Ye Wang, Acton Australian Capital Territory (AU); John Pye, Acton Australian Capital Territory (AU)

(21) Appl. No.: 17/061,731

(22) Filed: Oct. 2, 2020

(30) Foreign Application Priority Data
Oct. 4, 2019 (AU) 2019240717

(51) Int. Cl. G06T 15/55; G06T 17/20; G06T 15/04; G06T 7/33

(52) U.S. Cl. CPC G06T 15/55; G06T 17/20; G06T 15/04; F24S 2201/00; G06T 2207/10028; G06T 2207/10048; G06T 2207/10036; G06T 7/33

(57) ABSTRACT

The present disclosure provides a method (500) comprising receiving (510) images (e.g., 125A to 125G) of an object (110), the images (e.g., 125A to 125G) comprising first and second images. The method (500) then determines (530) feature points (810, 820) of the object (110) using the first images and determines (530, 540, 550) a three-dimensional reconstruction of a scene having the object (110). The method (500) then proceeds with aligning (560) the three-dimensional reconstruction with a three-dimensional mesh model of the object (110). The alignment can then be used to map (570) pixel values of pixels of the second images onto the three-dimensional mesh model. The directional radiosity of each mesh element of the three-dimensional mesh model can then be determined (580) and the hemispherical radiosity of the object (110) is determined (590) based on the determined directional radiosity.

### CROSS-REFERENCE TO RELATED APPLICATION

This application claims the benefit of priority to AU Application No. 2019240717, filed Oct. 4, 2019, the contents of which are hereby expressly incorporated by reference in their entirety.

### TECHNICAL FIELD

The present invention relates generally to image processing and, in particular, to processing images to determine radiosity of an object.

### BACKGROUND

A solar thermal receiver is a component of a solar thermal system that converts solar irradiation to high-temperature heat. Efficiency of the solar thermal receiver is reduced because energy losses (such as radiative reflection and thermal emission losses).

FIGS. 1A, 1B, and 1C show the sun irradiating a solar thermal receiver 110A, 110B, 110C. The irradiation 10 from the sun is then absorbed or reflected 12 by the solar thermal receiver 110A, 110B, 110C. The reflection 12 of the irradiation 10 is called radiative reflection loss. Once the irradiation 10 is absorbed, the solar thermal receiver 110A, 110B, 110C emits 14 heat that results in thermal emission loss. Therefore, only a portion of the irradiation 10 is absorbed and used by the solar thermal receiver 110A, 110B, 110C.

Measuring the radiative losses can provide an indication as to the efficiency of the solar thermal receiver 110A, 110B, 110C. However, such measurements are challenging due to the directional and spatial variations of the radiative reflection and thermal emission losses. Such measurements are made more difficult when the solar thermal receiver 110A, 110B, 110C is deployed on the field, due to the different environmental conditions and the requirement that the measurements cannot affect the operation of the solar thermal receiver 110A, 110B, 110C.

Conventional camera-based measurements enable direct observation of radiative reflection 12 and thermal emission 14 of a solar thermal receiver 110A, 110B. Cameras have been used to measure flux distributions on a flat billboard Lambertian target or on an external convex solar thermal receiver (e.g., the solar thermal receivers 110A, 110B) with the assumption that the solar thermal receiver 110A, 1108 has a Lambertian surface, where the directional radiative distributions are disregarded. Such an assumption is unimportant for the solar thermal receivers 110A, 1108 (having a flat or convex surface) as the radiation reflection 12 and thermal emission 14 do not interact further with the solar thermal receivers 110A, 1108.

However, cavity-shape solar thermal receivers (e.g., solar thermal receiver 110C) typically use objects having radiation reflected 10 and emitted 14 that are directional (unlike the non-directional Lambertian surface) to enable multiple reflection from the internal surface of the cavity shape, which in turn enable light-trapping effects. Therefore, assuming that the solar thermal receiver 110C has Lambertian surface would result in inaccurate results.

### SUMMARY

It is an object of the present invention to substantially overcome, or at least ameliorate, one or more disadvantages of existing arrangements.

Disclosed are arrangements which seek to address the above problems by determining the directional and spatial distribution of radiosity (e.g., reflection 12, thermal emission 14) from the surface of an object (e.g., a solar thermal receiver 110C). Such determination is performed by acquiring images of the object and processing the acquired images using a method of the present disclosure.

The present disclosure uses a solar thermal receiver to describe the method. However, it should be understood that the method of determining radiosity can be used on other objects (e.g., an engine, an electronic component, a heatsink, a furnace, a luminaire, a building, a cityscape, etc.).

According to an aspect of the present disclosure, there is provided a method comprising: receiving images of an object, the images comprising first and second images; determining feature points of the object using the first images; determining a three-dimensional reconstruction of a scene having the object; aligning the three-dimensional reconstruction with a three-dimensional mesh model of the object; mapping pixel values of pixels of the second images onto the three-dimensional mesh model; determining directional radiosity of each mesh element of the three-dimensional mesh model; and determining hemispherical radiosity of the object based on the determined directional radiosity.

According to another aspect of the present disclosure, there is provided a non-transitory computer readable medium having a software application program for performing a method comprising: receiving images of an object, the images comprising first and second images; determining feature points of the object using the first images; determining a three-dimensional reconstruction of a scene having the object; aligning the three-dimensional reconstruction with a three-dimensional mesh model of the object; mapping pixel values of pixels of the second images onto the three-dimensional mesh model based on the alignment; determining directional radiosity of each mesh element of the three-dimensional mesh model; and determining hemispherical radiosity of the object based on the determined directional radiosity.

Other aspects are also disclosed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some aspects of the prior art and at least one embodiment of the present invention will now be described with reference to the drawings and appendices, in which:

FIG. 1A shows a solar thermal receiver;

FIG. 1B shows another solar thermal receiver;

FIG. 1C shows yet another solar thermal receiver;

FIG. 2 is a system for determining radiosity of an object in accordance with the present disclosure;

FIG. 3 shows an example of images acquired by the system of FIG. 2;

FIG. 4A is a schematic block diagram of a general purpose computer system upon which the computer system of FIG. 2 can be practiced;

FIG. 4B is a detailed schematic block diagram of a processor and a memory;

FIG. 5 is a flow diagram of a method of determining hemispherical radiosity of an object according to the present disclosure;

FIG. 6 is a flow diagram of a sub-process of mapping pixel values of images to a three-dimensional (3D) mesh model of the object;

FIG. 7 is a flow diagram of a sub-process of assigning pixel values of an image to mesh elements;

FIG. 8 is an illustration of determining feature points of the object;

FIG. 9 is an illustration of a mesh element of the 3D mesh model;

FIG. 10A shows a projection of the mesh element onto a second image; and

FIG. 10B shows an example pixel h being located within the boundary of the projected mesh element.

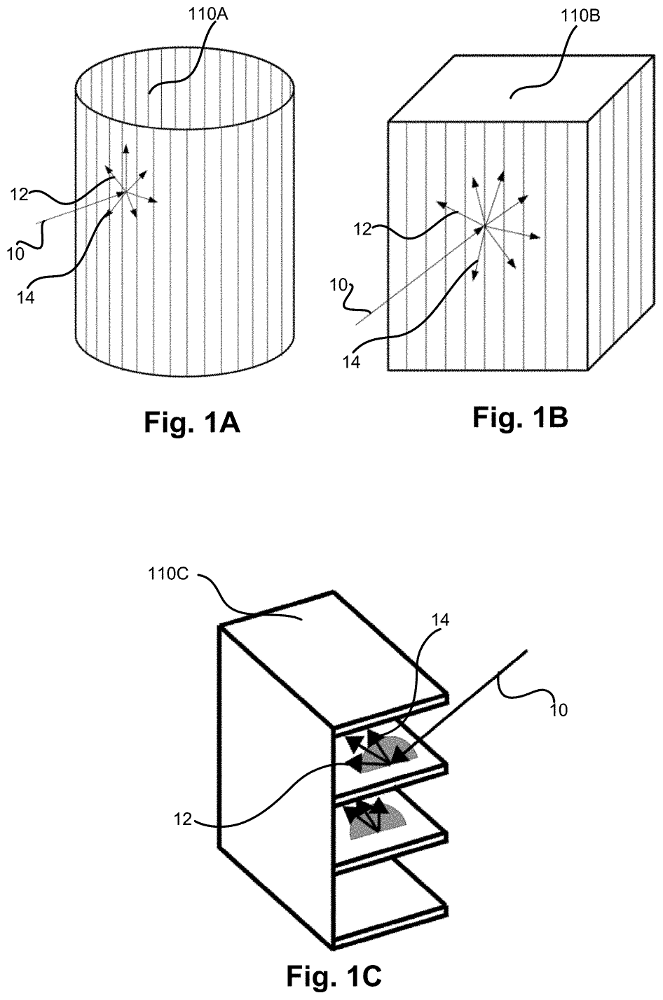

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

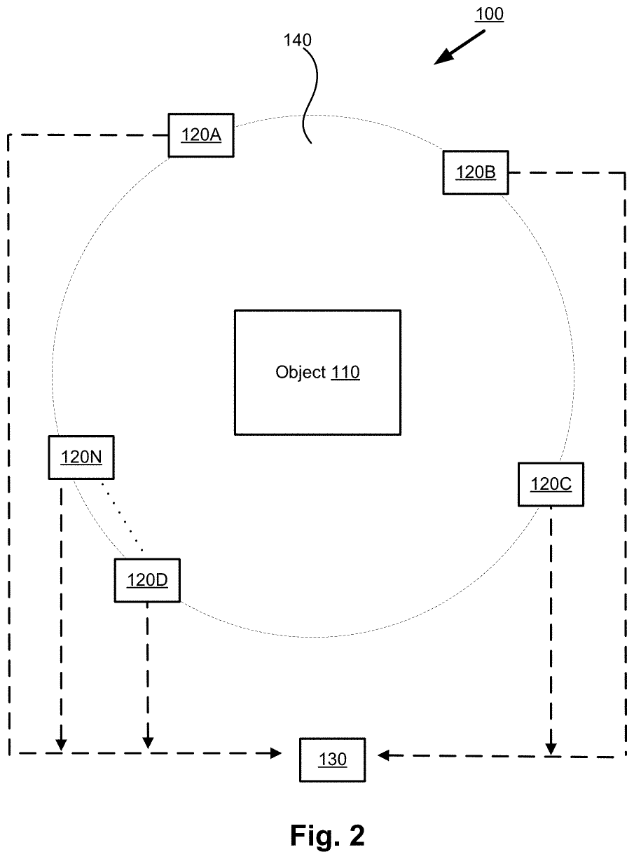

FIG. 2 shows a system 100 for determining radiosity of an object 110. The system 100 includes imaging devices 120A to 120N and a computer system 130. Each of the imaging devices 120A to 120N can be a coupled-charge device (CCD) camera (e.g., a digital single-lens reflex (DSLR) camera), a complementary metal-oxide-semiconductor (CMOS) camera, an infrared camera, a hyperspectral camera, and the like. Collectively, the imaging devices 120A to 120N will be referred to hereinafter as the imaging devices 120.

In one arrangement, the imaging devices 120 are located on drones to acquire images of the object 110. In another arrangement, each imaging device 120 includes multiple cameras (such as a combination of any one of the cameras).

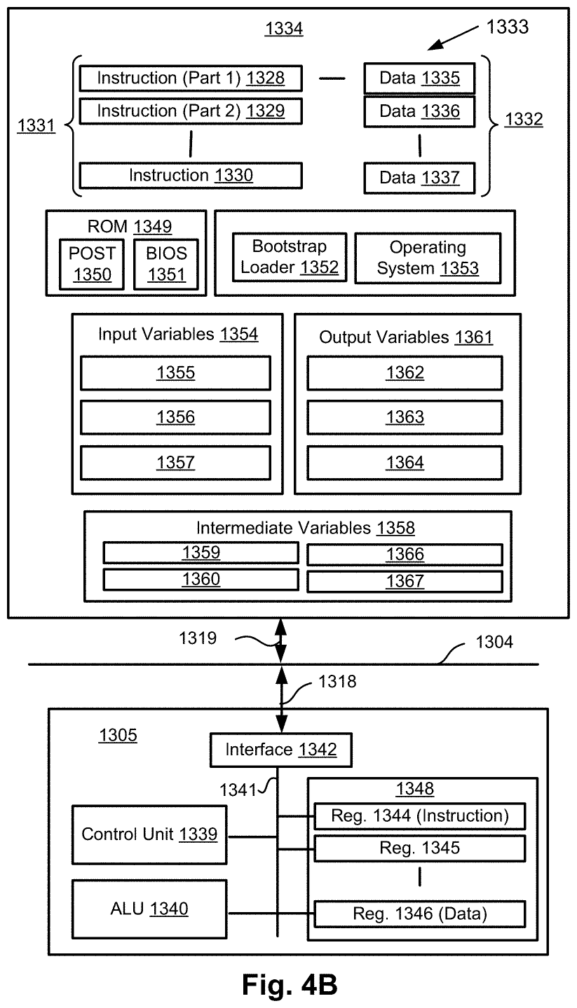

The imaging devices 120 are located in an area 140, which is a spherical area surrounding the object 110. The imaging devices 120 are in communication with the computer system 130, such that images acquired by the imaging devices 120 are transmitted to the computer system 130 for processing. The transmission of the images from the imaging devices 120 to the computer system 130 can be in real-time or delayed. When the computer system 130 receives the images from the imaging devices 120, the computer system 130 performs method 500 (see FIG. 5) to determine the directional radiosity of the object 110. The computer system 130 can then use the determined directional radiosity to determine the radiative losses (e.g., reflection 12, thermal emission 14), the flux distributions or temperature distributions on the object, and the like.

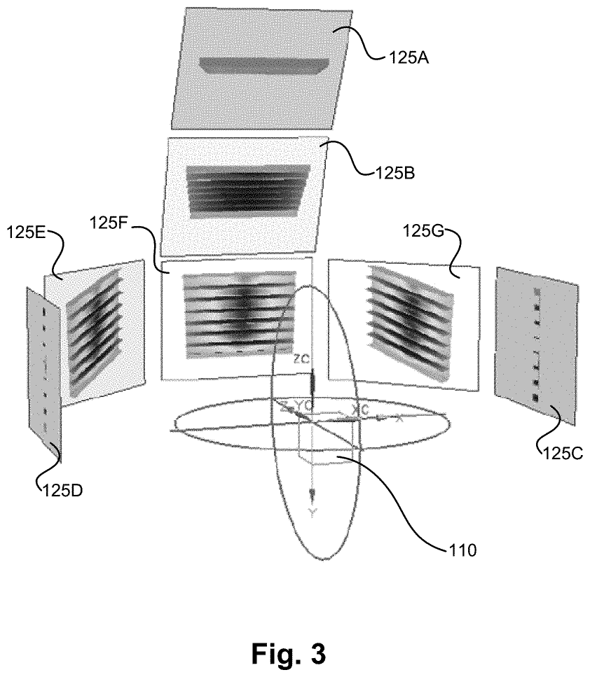

FIG. 3 shows images 125A to 125F of the object 110. The images 125A to 125F are captured by the imaging devices 120 in the area 140. The object 110 in FIG. 3 is the solar thermal receiver 110C, as can be seen at least in images 125B, 125E, 125F, and 125G.

### Computer System 130

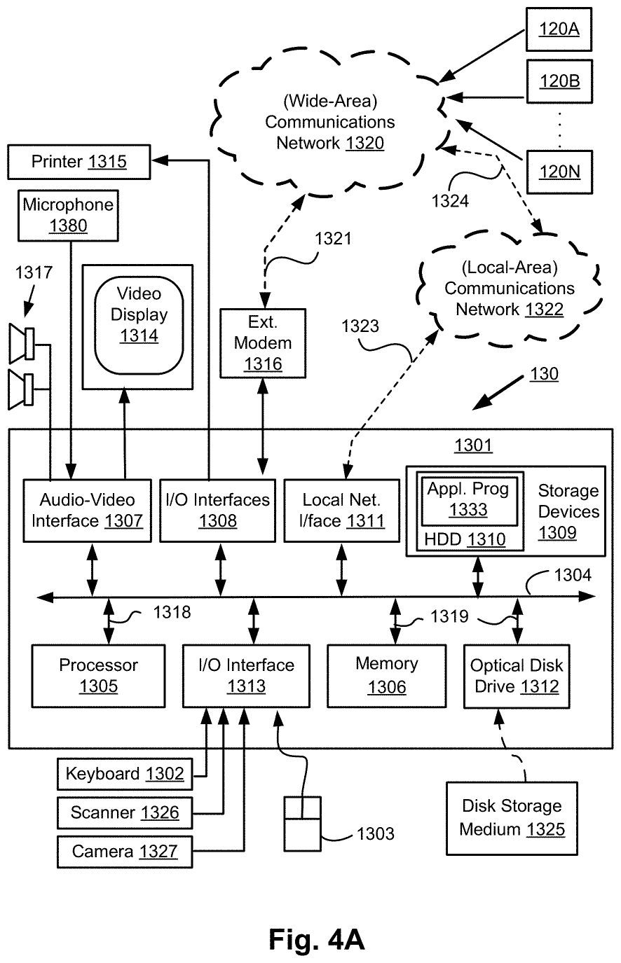

FIGS. 4A and 4B depict a general-purpose computer system 1300, upon which the various arrangements described can be practiced.

As seen in FIG. 4A, the computer system 130 includes: a computer module 1301; input devices such as a keyboard 1302, a mouse pointer device 1303, a scanner 1326, a camera 1327, and a microphone 1380; and output devices including a printer 1315, a display device 1314 and loudspeakers 1317. An external Modulator-Demodulator (Modem) transceiver device 1316 may be used by the computer module 1301 for communicating to and from a communications network 1320 via a connection 1321. The communications network 1320 may be a wide-area network (WAN), such as the Internet, a cellular telecommunications network, or a private WAN. Where the connection 1321 is a telephone line, the modem 1316 may be a traditional “dial-up” modem. Alternatively, where the connection 1321 is a high capacity (e.g., cable) connection, the modem 1316 may be a broadband modem. A wireless modem may also be used for wireless connection to the communications network 1320.

The computer module 1301 typically includes at least one processor unit 1305, and a memory unit 1306. For example, the memory unit 1306 may have semiconductor random access memory (RAM) and semiconductor read only memory (ROM). The computer module 1301 also includes an number of input/output (I/O) interfaces including: an audio-video interface 1307 that couples to the video display 1314, loudspeakers 1317 and microphone 1380; an I/O interface 1313 that couples to the keyboard 1302, mouse 1303, scanner 1326, camera 1327 and optionally a joystick or other human interface device (not illustrated); and an interface 1308 for the external modem 1316 and printer 1315. In some implementations, the modem 1316 may be incorporated within the computer module 1301, for example within the interface 1308. The computer module 1301 also has a local network interface 1311, which permits coupling of the computer system 1300 via a connection 1323 to a local-area communications network 1322, known as a Local Area Network (LAN). As illustrated in FIG. 4A, the local communications network 1322 may also couple to the wide network 1320 via a connection 1324, which would typically include a so-called “firewall” device or device of similar functionality. The local network interface 1311 may comprise an Ethernet circuit card, a Bluetooth® wireless arrangement or an IEEE 802.11 wireless arrangement; however, numerous other types of interfaces may be practiced for the interface 1311.

The I/O interfaces 1308 and 1313 may afford either or both of serial and parallel connectivity, the former typically being implemented according to the Universal Serial Bus (USB) standards and having corresponding USB connectors (not illustrated). Storage devices 1309 are provided and typically include a hard disk drive (HDD) 1310. Other storage devices such as a floppy disk drive and a magnetic tape drive (not illustrated) may also be used. An optical disk drive 1312 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 1300.

As shown in FIG. 4A, the imaging devices 120 are connected to the WAN 1320. In one arrangement, the imaging devices 120 are connected to the LAN 1322. In yet another arrangement, the imaging devices 120 are connected to the I/O Interfaces 1308.

The components 1305 to 1313 of the computer module 1301 typically communicate via an interconnected bus 1304 and in a manner that results in a conventional mode of operation of the computer system 1300 known to those in the relevant art. For example, the processor 1305 is coupled to the system bus 1304 using a connection 1318. Likewise, the memory 1306 and optical disk drive 1312 are coupled to the system bus 1304 by connections 1319. Examples of computers on which the described arrangements can be practised include IBM-PC's and compatibles, Sun Sparcstations, Apple Mac™ or like computer systems.

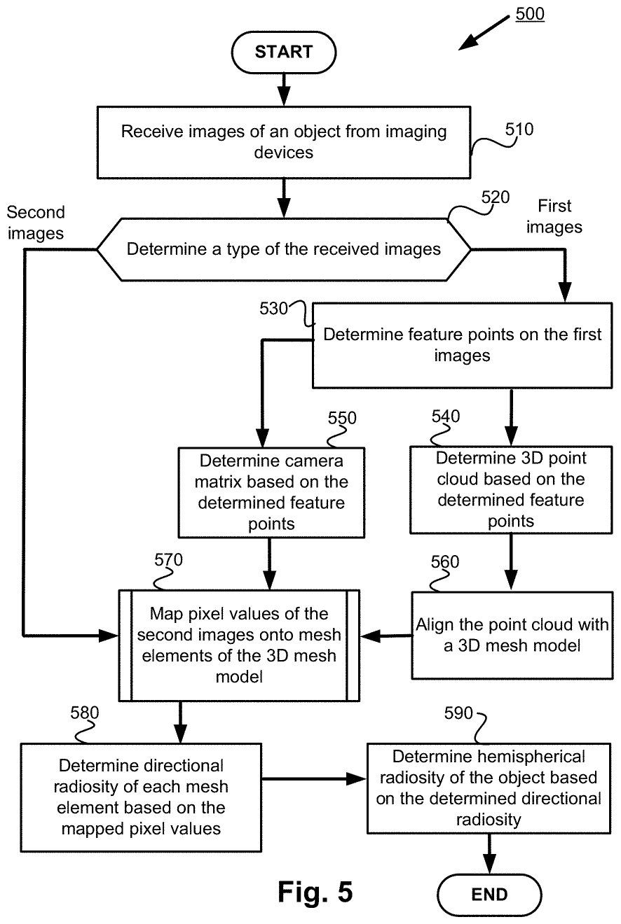

The method of determining radiosity of an object may be implemented using the computer system 130 wherein the processes of FIGS. 5 and 6, to be described, may be implemented as one or more software application programs 1333 executable within the computer system 130. In particular, the steps of the method of determining radiosity of an object are effected by instructions 1331 (see FIG. 4B) in the software 1333 that are carried out within the computer system 130. The software instructions 1331 may be formed as one or more code modules, each for performing one or more particular tasks. The software may also be divided into two separate parts, in which a first part and the corresponding code modules performs the radiosity determination methods and a second part and the corresponding code modules manage a user interface between the first part and the user.

The software may be stored in a computer readable medium, including the storage devices described below, for example. The software is loaded into the computer system 130 from the computer readable medium, and then executed by the computer system 130. A computer readable medium having such software or computer program recorded on the computer readable medium is a computer program product. The use of the computer program product in the computer system 130 preferably effects an advantageous apparatus for determining radiosity of an object.

The software 1333 is typically stored in the HDD 1310 or the memory 1306. The software is loaded into the computer system 130 from a computer readable medium, and executed by the computer system 130. Thus, for example, the software 1333 may be stored on an optically readable disk storage medium (e.g., CD-ROM) 1325 that is read by the optical disk drive 1312. A computer readable medium having such software or computer program recorded on it is a computer program product. The use of the computer program product in the computer system 130 preferably effects an apparatus for determining radiosity of an object.

In some instances, the application programs 1333 may be supplied to the user encoded on one or more CD-ROMs 1325 and read via the corresponding drive 1312, or alternatively may be read by the user from the networks 1320 or 1322. Still further, the software can also be loaded into the computer system 130 from other computer readable media. Computer readable storage media refers to any non-transitory tangible storage medium that provides recorded instructions and/or data to the computer system 130 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 1301. Examples of transitory or non-tangible computer readable transmission media that may also participate in the provision of software, application programs, instructions and/or data to the computer module 1301 include radio or infra-red transmission channels as well as a network connection to another computer or networked device, and the Internet or Intranets including e-mail transmissions and information recorded on Websites and the like.

The second part of the application programs 1333 and the corresponding code modules mentioned above may be executed to implement one or more graphical user interfaces (GUIs) to be rendered or otherwise represented upon the display 1314. Through manipulation of typically the keyboard 1302 and the mouse 1303, a user of the computer system 130 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1317 and user voice commands input via the microphone 1380.

FIG. 4B is a detailed schematic block diagram of the processor 1305 and a “memory” 1334. The memory 1334 represents a logical aggregation of all the memory modules (including the HDD 1309 and semiconductor memory 1306) that can be accessed by the computer module 1301 in FIG. 4A.

When the computer module 1301 is initially powered up, a power-on self-test (POST) program 1350 executes. The POST program 1350 is typically stored in a ROM 1349 of the semiconductor memory 1306 of FIG. 4A. A hardware device such as the ROM 1349 storing software is sometimes referred to as firmware. The POST program 1350 examines hardware within the computer module 1301 to ensure proper functioning and typically checks the processor 1305, the memory 1334 (1309, 1306), and a basic input-output systems software (BIOS) module 1351, also typically stored in the ROM 1349, for correct operation. Once the POST program 1350 has run successfully, the BIOS 1351 activates the hard disk drive 1310 of FIG. 4A. Activation of the hard disk drive 1310 causes a bootstrap loader program 1352 that is resident on the hard disk drive 1310 to execute via the processor 1305. This loads an operating system 1353 into the RAM memory 1306, upon which the operating system 1353 commences operation. The operating system 1353 is a system level application, executable by the processor 1305, to fulfil various high level functions, including processor management, memory management, device management, storage management, software application interface, and generic user interface.

The operating system 1353 manages the memory 1334 (1309, 1306) to ensure that each process or application running on the computer module 1301 has sufficient memory in which to execute without colliding with memory allocated to another process. Furthermore, the different types of memory available in the system 130 of FIG. 4A must be used properly so that each process can run effectively. Accordingly, the aggregated memory 1334 is not intended to illustrate how particular segments of memory are allocated (unless otherwise stated), but rather to provide a general view of the memory accessible by the computer system 130 and how such is used.

As shown in FIG. 4B, the processor 1305 includes a number of functional modules including a control unit 1339, an arithmetic logic unit (ALU) 1340, and a local or internal memory 1348, sometimes called a cache memory. The cache memory 1348 typically includes a number of storage registers 1344-1346 in a register section. One or more internal busses 1341 functionally interconnect these functional modules. The processor 1305 typically also has one or more interfaces 1342 for communicating with external devices via the system bus 1304, using a connection 1318. The memory 1334 is coupled to the bus 1304 using a connection 1319.

The application program 1333 includes a sequence of instructions 1331 that may include conditional branch and loop instructions. The program 1333 may also include data 1332 which is used in execution of the program 1333. The instructions 1331 and the data 1332 are stored in memory locations 1328, 1329, 1330 and 1335, 1336, 1337, respectively. Depending upon the relative size of the instructions 1331 and the memory locations 1328-1330, a particular instruction may be stored in a single memory location as depicted by the instruction shown in the memory location 1330. Alternately, an instruction may be segmented into a number of parts each of which is stored in a separate memory location, as depicted by the instruction segments shown in the memory locations 1328 and 1329.

In general, the processor 1305 is given a set of instructions which are executed therein. The processor 1305 waits for a subsequent input, to which the processor 1305 reacts to by executing another set of instructions. Each input may be provided from one or more of a number of sources, including data generated by one or more of the input devices 1302, 1303, data received from an external source across one of the networks 1320, 1302, data retrieved from one of the storage devices 1306, 1309 or data retrieved from a storage medium 1325 inserted into the corresponding reader 1312, all depicted in FIG. 4A. The execution of a set of the instructions may in some cases result in output of data. Execution may also involve storing data or variables to the memory 1334.

The disclosed radiosity determination arrangements use input variables 1354, which are stored in the memory 1334 in corresponding memory locations 1355, 1356, 1357. The radiosity determination arrangements produce output variables 1361, which are stored in the memory 1334 in corresponding memory locations 1362, 1363, 1364. Intermediate variables 1358 may be stored in memory locations 1359, 1360, 1366 and 1367.

Referring to the processor 1305 of FIG. 4B, the registers 1344, 1345, 1346, the arithmetic logic unit (ALU) 1340, and the control unit 1339 work together to perform sequences of micro-operations needed to perform “fetch, decode, and execute” cycles for every instruction in the instruction set making up the program 1333. Each fetch, decode, and execute cycle comprises:

a fetch operation, which fetches or reads an instruction 1331 from a memory location 1328, 1329, 1330;

a decode operation in which the control unit 1339 determines which instruction has been fetched; and

an execute operation in which the control unit 1339 and/or the ALU 1340 execute the instruction.

Thereafter, a further fetch, decode, and execute cycle for the next instruction may be executed. Similarly, a store cycle may be performed by which the control unit 1339 stores or writes a value to a memory location 1332.

Each step or sub-process in the processes of FIGS. 5 and 6 is associated with one or more segments of the program 1333 and is performed by the register section 1344, 1345, 1347, the ALU 1340, and the control unit 1339 in the processor 1305 working together to perform the fetch, decode, and execute cycles for every instruction in the instruction set for the noted segments of the program 1333.

The method of determining radiosity of an object may alternatively be implemented in dedicated hardware such as one or more integrated circuits performing the functions or sub functions of FIGS. 5 and 6. Such dedicated hardware may include graphic processors, digital signal processors, or one or more microprocessors and associated memories.

### Method 500 of Determining Radiosity of an Object

The rate of radiation leaving a specific location (at (x, y, z)) on a surface of the object 110 by reflection 12 and emission 14 (\dot{Q}ᵣ₊ₑ) at a wavelength A and in the direction (θ, φ) per unit surface area (A), per unit solid angle (Ω) and per unit wavelength interval is determined using the spectral directional radiosity equation:

$${J}_{λ} ( θ , ϕ , x , y , z ) = \frac{d {\dot{Q}}_{r + e} ( λ , θ , ϕ , x , y , z )}{d λ d Ω dA} \qquad ( 1 )$$

FIG. 5 is a flow diagram showing a method 500 of determining radiosity of an object 110. The method 500 can be implemented as a software application program 1333, which is executable by the computer system 130.

The method 500 commences at step 510 by receiving images of the object 110 from the imaging devices 120. An image of a solar thermal receiver (e.g., 110A, 1108, 110C) contains information of radiosity from the surface of the receiver. Each of the imaging devices 120 captures the images in a specific spectral range and from a single specific direction with a specific camera angle. The spectrum in which images are captured depends on the type of the imaging devices 120. A CCD camera acquires radiosity in the visible range, which predominantly comprises reflected solar irradiation 12. An infra-red camera acquires the radiosity in the infra-red range, which predominantly captures thermal emission 14 from the surface of the receiver 110A, 1108, 110C. A hyperspectral camera captures images at different specific spectrum range to obtain a breakdown of the radiative losses at each spectrum range.

For simple shape receivers 110A, 1108, an imaging device 120 can acquire an image of the entire receiver 110A, 1108 from a single camera position and orientation. However, for a complex-shaped cavity-like receiver 110C, it is not possible to capture all of the different surfaces of the receiver 110C in a single image. The difficulty in capturing all the surfaces in one image is shown in FIG. 3 where the different images 125A to 125G show different portions of the object 110C. Therefore, multiple images 125A to 125F of the receiver 110C from different directions are captured by the imaging devices 120, in order to capture all the features of the receiver 110C.

Therefore, in step 510, images of the object 110 (e.g., a receiver 110C) are taken by the imaging devices 120. The images can be randomly captured from many directions. The number of images assists in the 3D reconstruction step (step 530 of method 500).

The receiver 110C can be modelled with finite surface elements, each surface element locally having a relative direction to the imaging devices 120. The imaging devices 120 should be directed to cover (as far as practicable) the hemispherical domain of each individual surface element. In practical terms, the imaging devices 120 capture images of the object 110 around the spherical area 140.

For example, fora receiver with an aperture facing one side, the imaging devices 120 should capture images of the receiver in the spherical area 140 at the front of the receiver aperture. Therefore, a spherical radiosity of the object 110 can be established when multiple images are taken in the spherical area 140 surrounding the object 110. For a receiver with an aperture facing to the surrounding area (e.g., the solar thermal receiver 110A or 110B), the imaging devices 120 should capture images of the receiver in the spherical area 140 at the front of the receiver aperture.

Solar thermal receivers 110A, 1108, 110C operate at high-flux and high-temperature conditions. An imaging device 120 having a smaller camera aperture and/or a quicker shutter speed is used to capture images with low exposure, to ensure that the images are not saturated. In one arrangement, neutral density (ND) filters are used to avoid saturation. ND filters can reduce the intensity of all wavelengths of light equally, but ND filters do not perfectly reduce the intensity equally, which would bring additional measurement errors.

In addition to the low exposure images, identical images taken at higher exposure are required for 3D reconstruction (step 530). Higher exposure images capture features of the surrounding objects (e.g. the receiver supporting frame) to provide the necessary features for performing 3D reconstruction. The high exposure images are not valuable for determining the receiver losses, since many pixels will be saturated (at their maximum value) in the brightly illuminated part of the images.

Therefore, the images received at step 510 are taken by the imaging devices 120 from many directions surrounding the object 110. In particular, the imaging devices 120 capture images of the object from the spherical area 140 surrounding the object 110. Hereinafter, high exposure images will be referred to as the first images, while other images (e.g., low exposure images, infra-red images, hyperspectral images) will be referred to as the second images.

The method 500 proceeds from step 510 to step 520.

In step 520, the method 500 determines the type of the received images. If the received images are the first images, then the method 500 proceeds from step 520 to step 530. Otherwise (if the received images are the second images), the method 500 proceeds from step 520 to sub-process 570. Therefore, the received first images are used to develop the 3D mesh model (steps 530 to 560). Once the 3D mesh model is developed, the radiosity data of the object 110 (which is contained in the received second images) is mapped to the 3D mesh model generated using the first images.

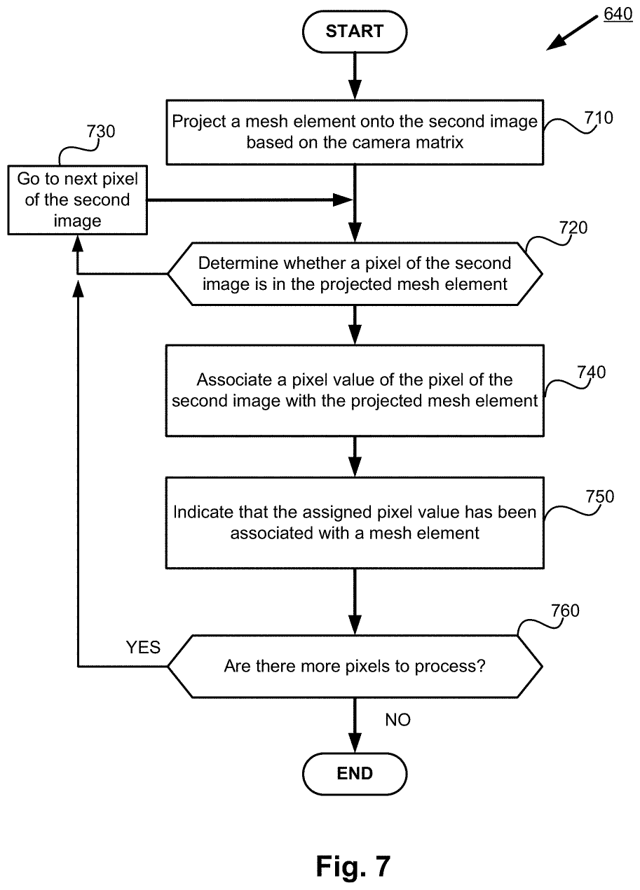

In step 530, the method 500 determines feature points on the first images. The first images are analysed to determine descriptors of an image point. The descriptors are the gradients of local pixel greyscale value in multiple directions, which can be calculated by using the scale-invariant feature transform (SIFT). If the same descriptors are found in another image, this point is identified as the identical point (i.e. feature point). FIG. 8 shows two feature points 810, 820 being identified from multiple images 125A to 125C captured by the respective imaging devices 120A to 120C. The identification of the feature points enables the position of a point in 3D space and the camera poses (i.e. position and orientation) of the imaging devices 120 to be constructed according to the principle of collinearity (called ‘triangulation’ in computer vision).

A solar receiver is exposed to high-flux solar irradiation, the radiosity of which may vary in different directions and disturb the feature detection by SIFT. Thus, the first images capturing constant features of the surrounding objects are used in the 3D reconstruction step.

When the feature points in images from different directions are identified, the triangulation method can be applied to establish their positions in the 3D space and the corresponding camera poses. This process is called structure from motion (SFM). It allows images to be taken in random positions, providing feasibility of incorporating with a drone flying in the solar field to inspect the performance of the receiver.

In one alternative arrangement, retro-reflective markers or 2D barcodes (e.g. ArUco code) are applied to the object 110 to provide specified feature points in images.

The method 500 proceeds from step 530 to steps 540 and 550.

In step 540, the method 500 determines 3D point cloud based on the determined feature points. The 3D point cloud comprises the feature points in the arbitrary camera coordinates. The 3D point cloud generated contains the object 110 as well as the surrounding objects and drifting noisy points. The method 500 proceeds from step 540 to 560.

In step 560, the 3D point cloud is aligned with a 3D mesh model. The 3D mesh model is a computer aided drawing (CAD) model of the object 110 that is discretised into a mesh element having a triangular shape. In alternative arrangements, the mesh element can be of any polygon shape.

Aligning the 3D point cloud to the 3D mesh model enables the object 110 to be distinguished from the surrounding points. Further, the 3D mesh model can be transferred into the camera coordinates and be projected onto each image plane by the corresponding camera matrix. Hence, the alignment of the 3D point cloud with the 3D mesh model provides a link between the surface of the object 110 and pixel data on each second image.

The 3D point cloud is aligned with the 3D mesh model by scaling, rotation, and transformation. At least four matching points are required to align the 3D point cloud with the 3D mesh model. The alignment can be optimised by minimising the distance between the two sets of points.

The method 500 proceeds from step 560 to sub-process 570. Before describing sub-process 570, step 550 is described first.

In step 550, the method 500 determines a camera matrix. The camera matrix (also called “projection matrix”) includes camera poses (i.e., the camera position and orientation of each image in the same coordinates) and a camera calibration matrix. The camera matrix is a 3 by 4 matrix that can project a 3D point onto the 2D image plane based on the principle of collinearity of a pinhole camera.

The method 500 proceeds from step 550 to sub-process 570.

As described above, the method 500 proceeds from step 520 to sub-process 570 if the method 500 determines that the received images are of a type classified as the second images (i.e., low exposure images, infra-red images, hyperspectral images). Similarly, the method 500 proceeds from steps 550 and 560 to sub-process 570. Therefore, sub-process 570 can be performed after aligning the 3D point cloud with the 3D mesh model.

Sub-process 570 maps the pixel values of the second images onto the 3D mesh model based on the alignment (performed at step 560) and the camera matrix (determined at step 550). In other words, sub-process 570 populates the 3D mesh model with the data of the second images. Each of the second images is processed by sub-process 570 in series so that the pixel values of one second image are mapped onto one or more mesh elements before processing the next second image. Sub-process 570 will be described below in relation to FIG. 6. The method 500 proceeds from sub-process 570 to step 580.

In step 580, the method 500 determines the directional radiosity of each mesh element of the 3D mesh model.

A factor K for converting a pixel value to energy (watt) is first determined.

The general equation to determine the factor K is as follows:

$$K = \frac{E}{P} \qquad ( 2 )$$

where K is a factor that converts a pixel value on a pixel to Watt, E is the rate of energy on the pixel (W/px²), P is the greyscale pixel value representing the brightness of the pixel, and px denotes the side length of the (square) pixel.

The factor K is constant if the imaging device 120 has a linear response to the irradiation 10 and the settings of the imaging devices 120 are kept constant.

In the present disclosure, the equation to determine the factor K is as follows:

$$K = \frac{{Q}_{r , c}}{Σ {P}_{ref}} \qquad ( 3 )$$

where Q_{r,c} is the energy reflected by a reference sample and received by the camera iris aperture A_{c}; and ΣP_{ref} is the sum of pixel values that represents the reference sample in the images.

Q_{r,c} is determined using the equation:

Q_{r,c}=IₙΩ_{c}Aᵣcosθᵣ (4)

where Iₙ is the radiance reflected from the reference sample; Aᵣ is the surface area of the reference sample; Ω_{c} is the solid angle subtended by the camera sensor iris from the point of view of the surface of interest, which is equal to A_{c}/l² where A_{c} is the camera iris aperture and l is the distance between the camera iris and the centre of the reference sample, and θᵣ is a direction of the camera.

Iₙ is determined using the equation:

$${I}_{n} = \frac{DNI \cdot ρ ( \vec{s} \cdot \vec{n} )}{π} \qquad ( 5 )$$

where ρ is the reflectivity of the reference sample; \vec{S} is the direction of the sun; and \vec{n} is the normal vector of the reference sample.

The energy reflected by the reference sample is determined using the equation:

DNI·Aᵣρ(\vec{s}·\vec{n})=πIₙAᵣ (6)

where DNI is a measurement of the direct normal irradiance of the sun on the surface of the reference sample.

To obtain the factor K of the third arrangement, a reference sample having a surface with diffuse reflectance, and known surface reflectivity and surface size and shape is used. The reference sample is arranged horizontally under the sun and images of the reference sample are captured by a camera. Equations (4) to (6) are then used to obtain equation (3).

The K factor of equation (3) can be used to determine the directional radiosity of each mesh element of the 3D mesh model.

Assuming a receiver mesh element i is associated with n pixels in an image from (θ, φ) direction (see sub-process 570), the radiation leaving a mesh element i that is received by the iris aperture of an imaging device 120 can be calculated using the equation:

$${\dot{Q}}_{i , c} = K \cdot {\sum }_{j = 1}^{n} ( {P}_{i , j} \cdot {px}^{2} ) \qquad ( 7 )$$

where P_{i,j} is the greyscale pixel value representing the brightness of a pixel j mapped at a mesh element i; and px denotes the side length of the (square) pixel.

Assuming the directional radiosity of the object 110 from the mesh element i in the camera direction is Iᵢ(θ, φ), then

\dot{Q}_{i,c}=Iᵢ(θ, φ)·Ω_{c}·Aᵢ cos(θ) (8)

where Aᵢ is the area of the mesh element, and are the zenithal and azimuthal angle between the normal vector of the mesh element and the direction of the imaging device 120 (see the discussion on step 590), and

$${Ω}_{c} = \frac{{A}_{c}}{{L}^{2}}$$

is the solid angle subtending at the camera iris aperture of the imaging device 120 when viewed from the mesh element i, L is the distance between the imaging device 120 and the mesh element.

The directional radiosity of the object 110 from the mesh element i in the direction of (θ, φ) is then obtained by combining equation (3) with equations (8) and (9). The directional radiosity equation is as follows:

$${I}_{i} ( θ , ϕ ) = DNI \cdot \frac{{L}^{2}}{{A}_{i} cos ( θ )} \cdot \frac{{\sum }_{j = 1}^{n} {P}_{i , j}}{{\sum }_{j = 1}^{m} {P}_{sun , j}} \qquad ( 9 )$$

The method 500 proceeds from step 580 to step 590.

In step 590, the method 500 determines the hemispherical radiosity of the object 110 based on the determined directional radiosity.

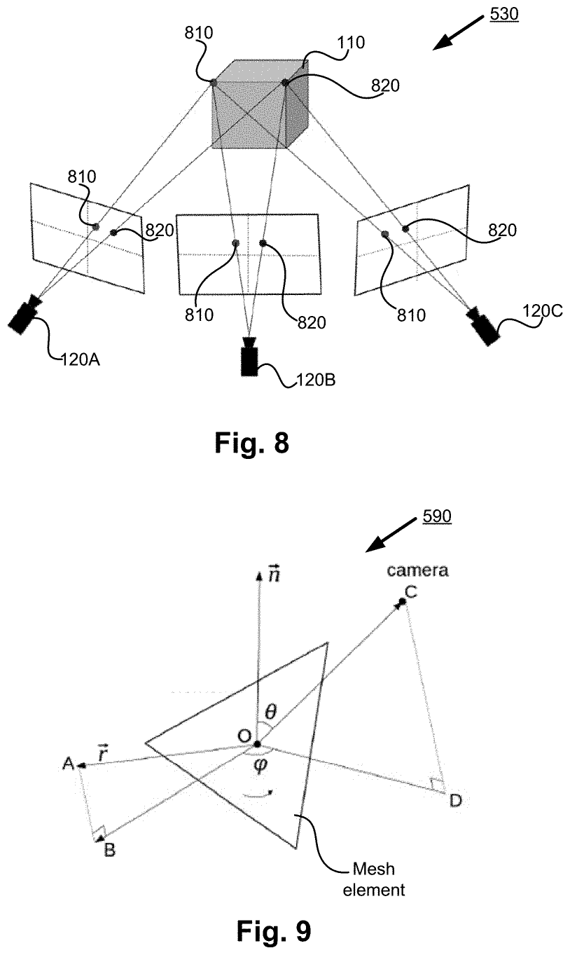

The directional radiosity of each mesh element (determined at step 580) is integrated in the hemispherical directions to determine the hemispherical radiosity of the object 110. It should be noted that the camera direction is defined locally at each individual mesh element by the zenithal angle θ and azimuthal angle φ, as shown in FIG. 9. The zenithal angle θ is defined as the angle between \vec{n} (the normal vector of the mesh element) and \vec{OC} (a vector between the centre O of the mesh element and the position C of the image device 120):

$$θ = arccos ( \frac{\vec{n} \cdot \vec{OC}}{\vert \vec{n} \vert \vert \vec{OC} \vert} ) \qquad ( 10 )$$

where \vec{n} is the normal vector of the mesh element, O is the centre of the mesh element, and C is the position of the imaging device 120 that is obtained at step 550. A global reference vector \vec{r} is assigned manually to define the starting point of a local azimuth angle φ. As shown in FIG. 9, a point A can be found in the reference direction from the centre of the mesh element. The projection of point A and the camera position C on the surface plane are points B and D, respectively. The azimuthal angle φ is from \vec{OB} counter-clockwise to \vec{OD} according to the right-hand rule:

$$ϕ = arccos ( \frac{\vec{OB} \cdot \vec{OD}}{\vert \vec{OB} \vert \vert \vec{OD} \vert} ) \qquad ( 11 )$$

The total radiative losses from the mesh element i is calculated by integrating the radiance distribution Iₜ(θ, φ)over the hemisphere:

$${\dot{Q}}_{i} = {\int \int }_{hemisphere} {I}_{i} ( θ , ϕ ) d ω {A}_{i} cos θ \qquad ( 12 )$$

The radiance distribution can then be used for determining temperature distribution, flux distribution, and the like of the object 110.

The method 500 concludes at the conclusion of step 590.

### Sub-Process 570

FIG. 6 shows a flow chart diagram of sub-process 570 of mapping the data of the second images onto the 3D mesh model. Sub-process 570 can be implemented as a software application program 1333, which is executable by the computer system 130. Sub-process 570 is performed for each second image until all the related pixel values of the second images are mapped onto the mesh elements of the 3D mesh model.

Sub-process 570 commences at step 610 by determining mesh elements of the 3D mesh model that are facing the direction of the second image (which is currently being processed by the sub-process 570). Step 610 therefore disregards mesh elements that are not relevant for a particular second image.

For example, an imaging device 120 faces the north to capture an image of the object 110. Such an imaging device 120 would capture the south facing surface (i.e., mesh elements) of the object 110 but would not capture the north facing surface (i.e., mesh elements) of the object 110.

As the imaging devices 120 capture images of the object 120, the positions of the imaging devices 120 are known. As described in step 550, the camera matrix stores the respective positions of the imaging devices 120. For ease of description, the camera positions can be denoted by C(x_{C}, y_{C}, z_{C}) and the camera matrices can be denoted by P=K[R|t].

As described above, the 3D mesh model of the object 110 includes mesh elements.

For each mesh element i, the following is known:
Centre of element: O(x_{O}, y_{O}, z_{O})
The vertices: V₁(x₁, y₁, z₁), V₂(x₂, y₂, z₂), V₃(x₃, y₃, z₃) . . .
Normal vector of the surface element: n(xₙ, yₙ, zₙ)

To determine whether a mesh element is facing the second image, sub-process 570 checks whether OC·n≥90°. If this condition is met, then the mesh element is excluded. However, if the condition is not met, then the mesh element is determined to be a mesh element that faces the second image.

Once the relevant mesh elements for an image are determined, sub-process 570 proceeds from step 610 to step 620.

In step 620, sub-process 570 determines an order of the relevant mesh elements (determined at step 610) based on the positions of the mesh elements and the second image. In one arrangement, the determination is performed by calculating the distance of each relevant mesh element to the second image, where the distance is between the centre O of each mesh element and the position of the imaging device capturing the second image. In another arrangement, an octree technique is implemented to determine the closest mesh elements.

The determined mesh elements are therefore ordered where the mesh element closest to the imaging device position is ranked first. Sub-process 570 proceeds from step 620 to sub-process 640 for processing the determined mesh elements according to the ordered rank. Each determined mesh element is processed by sub-process 640 to map the pixel values of the second image to the mesh element. The closest mesh element is first processed by sub-process 640 to map certain pixel values of the second image to that closest mesh element. Once the certain pixel values are mapped to the closest mesh element, the certain pixel values are set to 0. Setting the certain pixel values to 0 prevent the same pixel value from being assigned to multiple mesh element. More importantly, the same pixel value cannot be assigned to a mesh element behind the mesh element closer to the image.

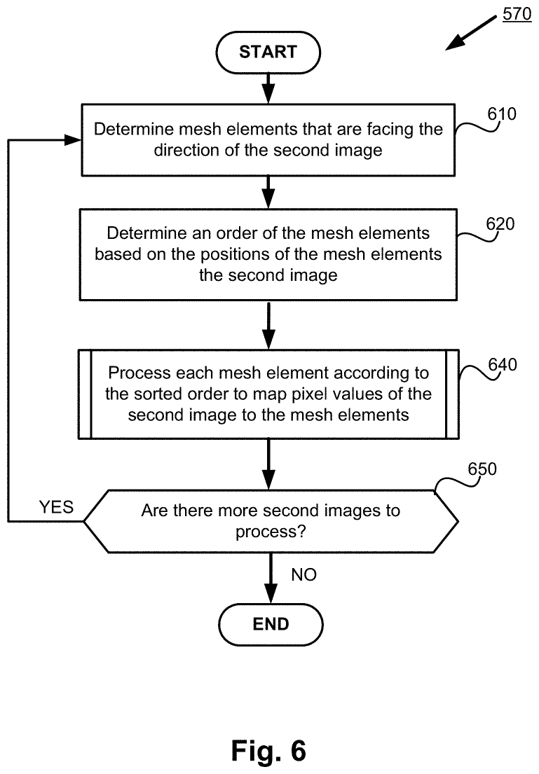

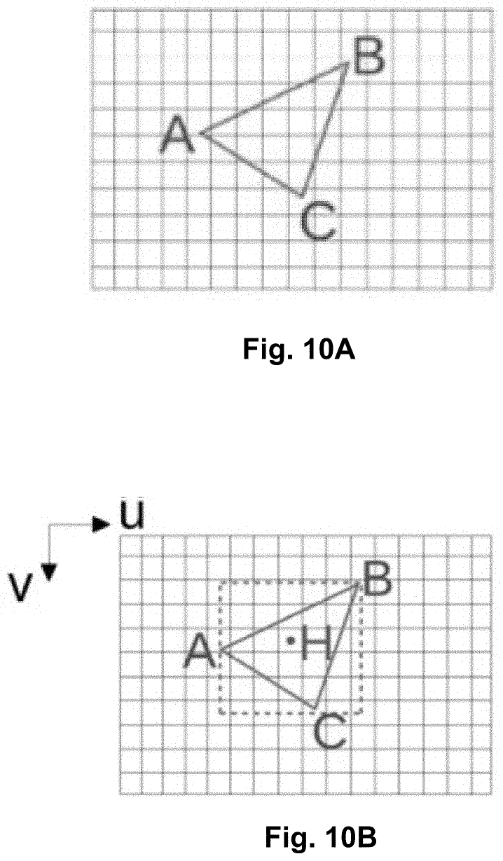

Sub-process 640 is shown in FIG. 7 and commences at step 710. The mesh element currently being processed by sub-process 640 is projected onto the second image (which is currently being processed by sub-process 570) based on the camera matrix. FIG. 10A shows the projection of the mesh element onto the second image. As can be seen in FIG. 10A, the projected mesh element defines a boundary, in which h pixels of the second image are located. Sub-process 640 proceeds from step 710 to step 720.

In step 720, sub-process 640 determines whether a pixel of the second image is within the boundary of the projected mesh element. FIG. 10B shows an example of a pixel h being located within the boundary of the projected mesh element. To determine whether the pixel h is within the boundary, the test of ΔHBC+ΔAHC+ΔABH=ΔABC is carried out. The test adds the areas defined by (1) pixel h and corners B and C, (2) pixel h and corners A and C, and (3) pixel h and corners A and B, and determines whether the added areas equal to the area defined by the corners A, B, and C. If the added areas equal to the area defined by the corners A, B, and C, then the pixel h is within the boundary. If the pixel is within the boundary (YES), sub-process 640 proceeds from step 720 to step 740. Otherwise, if the pixel is not within the boundary (NO), sub-process 640 moves to the next pixel on the second image and returns to step 720.

In step 740, the pixel value of the determined pixel is associated with the projected mesh element. In other words, the pixel value now belongs to the mesh element. Sub-process 640 proceeds from step 740 to step 750.

In step 750, the pixel value that has been associated with the mesh element is indicated to have been assigned to prevent the pixel value from being assigned to more than one mesh elements. In one arrangement, the associated pixel value is set to zero. In another arrangement, each pixel value has a flag to indicate whether the pixel value has been associated with a mesh element. If the pixel value is associated with a mesh element, the flag indicates so. Sub-process 640 proceeds from step 750 to step 760.

In step 760, sub-process 640 determines whether there are more pixels to process in the second image. If YES, sub-process 640 proceeds to step 730. In step 730, sub-process 640 moves to the next pixel, then returns to step 720. If NO, sub-process 640 concludes. At the conclusion of sub-process 640, the pixel values of all the relevant pixels of one second image are assigned to the mesh elements of the 3D mesh model.

Sub-process 570 then proceeds from sub-process 640 to step 650.

In step 650, sub-process 570 checks whether there are more second images to process. If YES, sub-process 570 returns to step 610 to process the next second image. If NO, sub-process 570 concludes. At the conclusion of sub-process 570, all the second are processed so that the pixel values of the second images are associated with the mesh elements of the 3D mesh model.

### INDUSTRIAL APPLICABILITY

The arrangements described are applicable to the computer and data processing industries and particularly for applications for determining radiosity of an object.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method comprising:
receiving images of an object, the images comprising first and second images;
determining feature points of the object using the first images;
determining a three-dimensional reconstruction of a scene having the object;
aligning the three-dimensional reconstruction with a three-dimensional mesh model of the object;
mapping pixel values of pixels of the second images onto the three-dimensional mesh model based on the alignment;
determining directional radiosity of each mesh element of the three-dimensional mesh model; and
determining hemispherical radiosity of the object based on the determined directional radiosity.

2. The method of claim 1, wherein the three-dimensional reconstruction produces camera matrices for imaging devices capturing the received images, and three-dimensional point cloud, wherein the alignment of the three-dimensional reconstruction with the three-dimensional mesh model is based on the three-dimensional point cloud.

3. The method of claim 1, wherein the mapping of pixel values of pixels of the second images comprises:
determining mesh elements relating to one of the second images;
determining an order of the determined mesh elements based on the positions of the determined mesh elements and the one of the second images; and
assigning pixel values of the one of the second images to the determined mesh elements based on the order.

4. The method of claim 3, wherein the mapping of pixel values of pixels of the second images further comprises:
indicating that the assigned pixel values are associated with one of the determined mesh elements.

5. The method of claim 1, wherein the first images comprise high exposure images, and the second images comprises any one of low exposure images, infra-red images, and hyperspectral images.

6. A non-transitory computer readable medium having a software application program for performing a method comprising:
receiving images of an object, the images comprising first and second images;
determining feature points of the object using the first images;
determining a three-dimensional reconstruction of a scene having the object;
aligning the three-dimensional reconstruction with a three-dimensional mesh model of the object;
mapping pixel values of pixels of the second images onto the three-dimensional mesh model based on the alignment;
determining directional radiosity of each mesh element of the three-dimensional mesh model; and
determining hemispherical radiosity of the object based on the determined directional radiosity.

7. The computer readable medium of claim 6, wherein the three-dimensional reconstruction produces camera matrices for imaging devices capturing the received images, and three-dimensional point cloud, wherein the alignment of the three-dimensional reconstruction with the three-dimensional mesh model is based on the three-dimensional point cloud.

8. The computer readable medium of claim 6 or 7, wherein the mapping of pixel values of pixels of the second images comprises:
determining mesh elements relating to one of the second images;
determining an order of the determined mesh elements based on the positions of the determined mesh elements and the one of the second images; and
assigning pixel values of the one of the second images to the determined mesh elements based on the sorted order.

9. The computer readable medium of claim 8, wherein the mapping of pixel values of pixels of the second images further comprises:
indicating that the assigned pixel values are associated with one of the determined mesh elements.

10. The computer readable medium of claim 6, wherein the first images comprise high exposure images, and the second images comprises any one of low exposure images, infra-red images, and hyperspectral images.
